(19) United States
(12) Patent Application Publication
(10) Pub. No.: US 2010/0184500 A1
(43) Pub. Date: Jul. 22, 2010

(54) System and method of using gaming software technology to motivate the use of business software

(76) Inventor: Peter Beasley, Dallas, TX (US)

Correspondence Address: Steven Thrasher, 391 Sandhill Dr., Richardson, TX, 75080, US

(21) Appl. No.: 12/655,545

(22) Filed: Jan. 6, 2010

Related U.S. Application Data
(60) Provisional application No. 61/204,266, filed on Jan. 6, 2009.

(51) Int. Cl. A63F 9/24; G09B 3/00

(52) U.S. Cl. 463/9; 434/322

(57) ABSTRACT

The invention teaches using gaming software technology to motivate the use of business software. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATIONS

This application is related to, and claims priority from U.S. Provisional Patent Application 61/204,266 entitled System and Method to Use Gaming Technology to Enhance Network Systems Management Solutions, to Beasley, filed Jan. 6, 2009.

### TECHNICAL FIELD OF THE INVENTION

The invention relates to gaming software.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

The Information Technology Infrastructure Library (ITIL®) was created to improve the management of distributed IT computer networks. This library defines a Configuration Management Database (CMDB), which is a repository of various types of information about IT computer networks. Numerous software programs and patent applications have since been created to embody or define a CMBD. This includes products like Computer Associate's UniCenter, BMC Software's Remedy Asset Management, and FrontRange's ITSM. Other products and patent applications exist too. These products suffer from the likelihood of 1) disuse or 2) having inaccurate data.

CMDBs require the entry of a significant amount of information that is not auto-discoverable or populated electronically, and therefore rely on IT technologists to manually enter a significant amount of data. Accordingly, CMDB implementations will not accomplish their intended goals unless IT professionals use the system. The lack of system use leads to a lack of critical data. The lack of critical data leads to data inaccuracies, which leads further to a lack of system use. What is needed is a method to influence the behavior of IT technologists such that they will use Network Systems Management (NSM) systems.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 is a flowchart of an embodiment of a method according to the invention.

FIG. 2 depicts a schematic diagram of a hardware system according to an embodiment of the invention.

FIG. 3 depicts a schematic diagram of a system according to an embodiment of the invention.

FIG. 4 is a flowchart of a method of login and registration according to an embodiment of the invention.

FIG. 5 illustrates a graphical user interface according to an embodiment of the invention.

FIG. 6 illustrates a graphical user interface according to an embodiment of the invention, illustrating an exemplary trivia question.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points.

First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the Claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Unless otherwise indicated, acronyms used have the ordinary meaning of those acronyms in the context presented, and are readily understood by those of ordinary skill in the art. Words and phrases are to be given their ordinary plain meaning unless indicated otherwise.

### Invention Overview

The invention includes four basic components.

A. Fun—defined as a source of enjoyment, amusement, or pleasure—is one element of my invention to influence IT technologists to use NSM and CMDB solutions. Few people enjoy boredom. Likewise, many people do not like “documentation.” Adding fun to the process of IT system documentation takes away the monotony that many network systems management systems suffer. The invention employs finding a fun way to entice people to use a network systems management system.

In particular, this invention employs the use of software games as a fun method to encourage people to use CMDB solutions. A software game is defined as software algorithms and user interfaces used by one or more individuals for their own enjoyment, amusement, or pleasure or for the enjoyment, amusement, or pleasure of others that enables a competitive activity involving skill or chance, which is not software to simulate, teach or increase skills in the competitive activity itself.

For example, most organizations have rules or procedures on how they manage their assets. In large organizations, these rules can be confusing or misunderstood by the group of people who use or support those assets. By using simple on-line testing of these rules and procedures, a NSM system can create a fun game out of the learning experience. Playing the game within the NSM system helps people learn the organization's rules, but also entices people to use the asset management system. The underlying effect is that as more people use the system, the system will have more complete information.

This type of game is not a simulator. Also, there is no intent or purpose of the software to increase the skill of the user in answering questions (the competitive activity itself). Instead, the use of a software game has a purpose to provide enjoyment, amusement or pleasure. While some people may enjoy using software for accounting, accounting software is generally used to perform accounting. Similarly, while some people may not enjoy Trivia Games, a purpose of a trivia game is to provide enjoyment, amusement or pleasure.

Therefore, in the context of this invention, a simulator of a particular business activity is not a game. Also, business software that some people enjoy using does not make that business software a game. And lastly, the fact that not everyone enjoys, is amused, or gains pleasure from a software algorithm or user interface that has the intent to provide enjoyment, amusement or pleasure does not exclude the software from being regarded a game.

B. A second component of the invention is to add gaming technology to business software in a manner that supports but does not interfere with the business mission. Educational games, as an example, can be added to network systems management solutions as a method to encourage system use without interfering with business priorities. Businesses have an inherent mission to educate their employees on their internal policies and procedures and an education game that tests staff knowledge about IT procedures can help IT technologists learn.

The addition of fun games to business software, network systems management software in particular, cannot be employed in a manner that would detract from the business mission of the organization, or in a manner that interferes with business priorities (if this were the case, quite understandably, many companies or IT departments would not encourage their employees to play games during work hours). Accordingly, the addition of the educational game should not detract from the use of the network management system; but rather encourage its use.

Therefore, the added game cannot allow players to extend play, compete directly against each other, or simply play the game. The added game merely complements the use of the business software, network systems management system, or a CMDB.

C. A third aspect of the invention, in one embodiment, is for the added game to employ an element of chance. The unpredictability of games of chance increases excitement and minimizes monotony. Again, in the present embodiment, the added game minimizes the boredom associated with IT system documentation and therefore an exciting, unpredictable game tends to hide the underlying monotony in using network system management systems.

D. A fourth aspect is that games that provide social competitiveness can enhance the use of network systems management systems. Scoring of the game should be conducted in a manner that identifies who is winning as the game is played. One embodiment that incorporates the elements of this invention is an electronic trivia-game within the System Asset Management System™ by Net Watch Solutions, Inc. The Mitzi™ game feature helps system users maintain their IT information. With this invention, people who start the application are presented with a single question. The question is one of several entered by a system administrator who is a person within the organization.

The questions can be about the organization's rules, questions about the organization's assets, or any question that serves the purpose to educate and entice people to use the system. Sample questions include:
Up to how much do companies typically save by using asset management techniques?
Which time of the week does the organization allow for network changes?
When outages occur after hours, how soon must support people respond to a call for help?

Once viewing the question, the person is presented with possible answers, which are defined “answer parameters”. As with the original question, these possible answers are set-up in advance by the system administrator. The answers can be computed by the system, which we define as “passive” to the system administrator, or “non-passive”, answers those explicitly defined by the system administrator.

A question, “how many additional servers has the company grown in the last year” could be set-up with a passive answer, computed from data in the NSM system itself Conversely, a question, “who in the group is acclaimed to be known to have the most cynical sense of humor”, could be set-up with non-passive answers, “Sally, Michael, Jay or Mr. McGoo”.

The use of passive, non-passive, and “funny answers” (i.e. Mr. McGoo) are ideal characteristics of this invention. The underlying goal is to entice people to use the business software. A thoughtful use of answer parameters aids this goal.

The person has a brief period, perhaps two seconds per answer, to select the correct answer. Once selecting an answer or after the expiration of the time period, the correct answer is displayed. The system allows the administrator to enter numerous question and answer pairs. As people login to use the system, they are automatically presented with random questions at each logon. Similarly, the potential answers are displayed in random order.

Accordingly, each time the person uses the system they are given a random game question to answer. The NSM system identifies the people who answer the most questions correctly. These individuals are awarded with a title, such as “This Period's Service Management Leaders”, or other recognition that can be observed by others.

### Summary of the Overview

Accordingly, the invention adds a fun game to a NSM system in a manner that does not detract from the use of the NSM system, may include the element of chance, and may provide social competitiveness. Additionally, the invention may incorporate an electronic trivia-game that incorporates real facts from the data in the NSM system, and/or real procedures about the organization of the NSM system, and/or real facts about the people who use the NSM system.

### Description of the Drawings

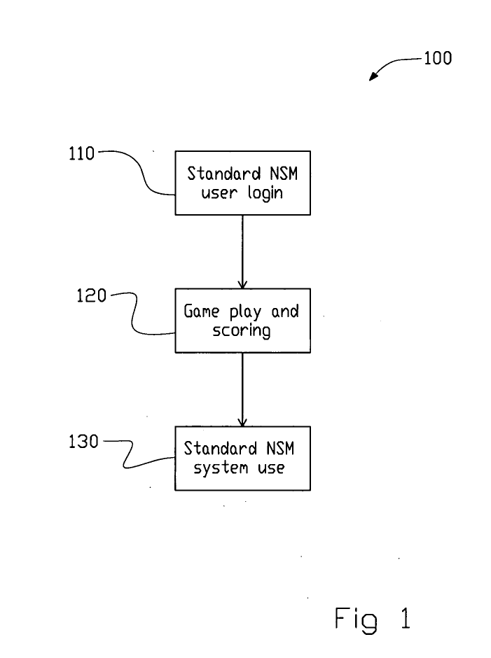

FIG. 1 is a flowchart illustrating an embodiment of the present invention, including the steps of NSM User Login 110, Game Play and Scoring 120, and NSM System Use 130. Embodiments of this invention could insert the game between other NSM components. For example, as shown, the game associated with this invention is added to the existing operation of a NSM solution. This particular embodiment inserts the game after the standard NSM login 110 and before the standard NSM system use 130.

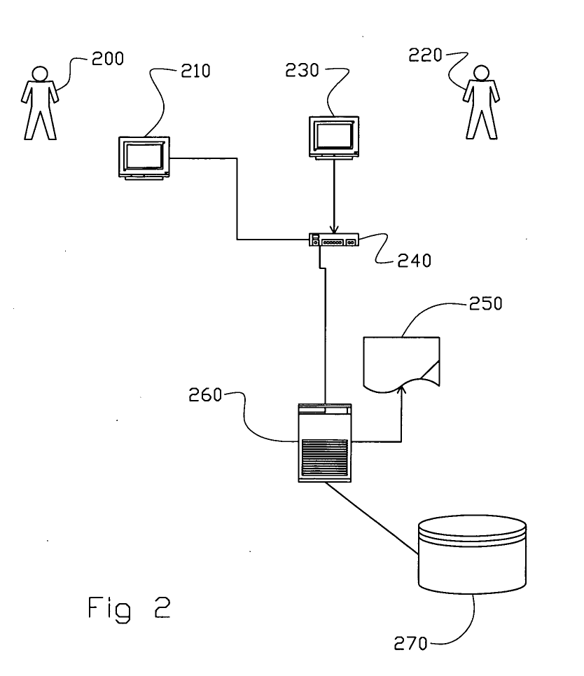

FIG. 2. depicts a schematic diagram of a hardware system according to an embodiment of the invention. NSM software 250 operates on a server 260 and is accessed by multiple users 200, 220 using multiple computers 210, 230, respectably, across a computer network 240. The NSM software 250 relies on a database repository 270, which may be a configuration management database. The standard NSM login process is used to identify the particular user that plays the game. As described further, the database repository 270 will also be used to track the game score for each player.

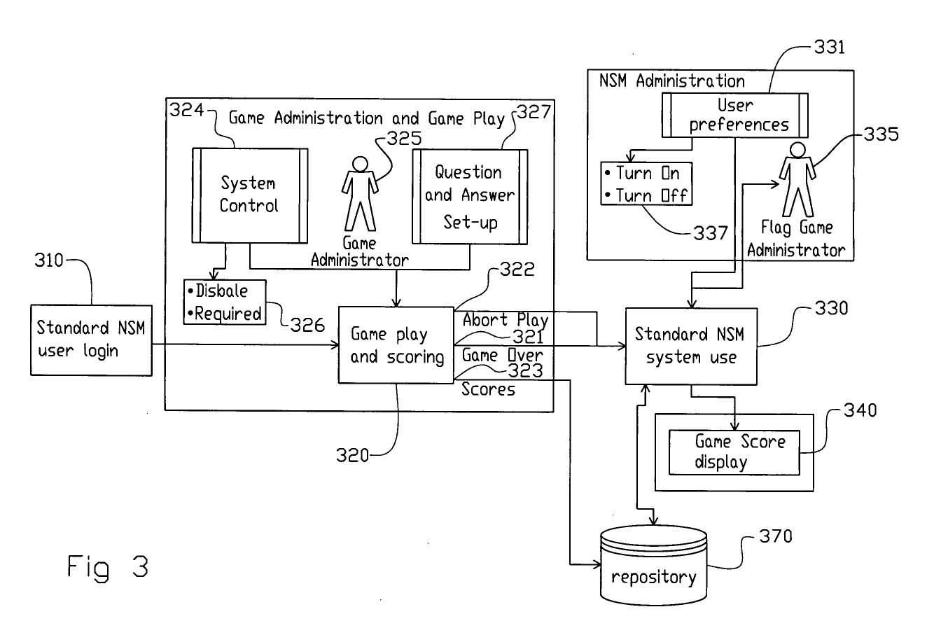

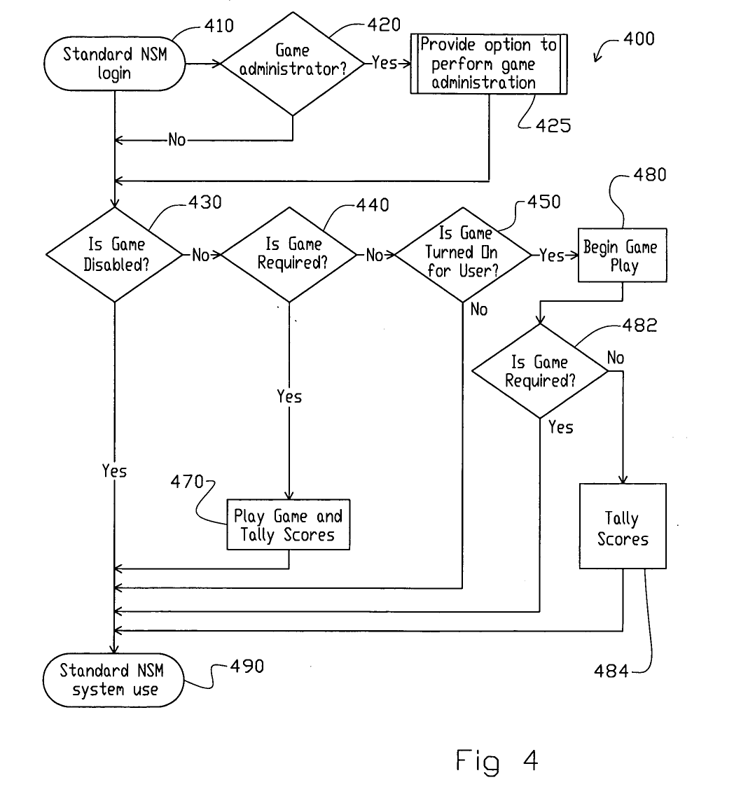

FIG. 3 depicts a schematic diagram of a system according to an embodiment of the invention. The standard administration portion of the NSM application is modified to allow an existing NSM system user to be flagged in the repository 370 as the Game Administrator 325. The NSM user who is flagged as a Game Administrator has the capability of manipulating the game System Control 324 and Question and Answer Set-up 327 modules. The System Control 324 module is used to define game operation as either 1) Disabled for all users, or 2) Required 326. The Question and Answer Set-up 327 module is used to create trivia questions and their associated answers. Additionally, the standard administration portion of the NSM application is modified to allow individual users to 1) Turn On or 2) Turn Off game play 337.

As described earlier, Game Play 320 cannot interfere with business use of the NSM application. When the game play is over 321, application control is passed back to the NSM application, 320. There is no ability to continue playing the game. If the Game Administrator 325 does not set game play as Disabled or Required 326, the user has the ability to Abort 322 game play and immediately work in the NSM system. As various NSM users play the game, scores are tallied and saved 323 in the NSM database repository 370. The NSM application is modified to display the game winners 340.

FIG. 4 is a flowchart of a method of login and registration according to an embodiment of the invention. This flowchart relies on the administrative settings described in FIG. 3 (game disabled, game required, turned on, and turned off) to determine when the game is bypassed, played or can be aborted. FIG. 4 illustrates a standard NSM login 410. The method then proceeds to a game administrator inquiry 410. If in the game administrator inquiry 410 is it determined that the administrator is logging in, then the method proceeds to the Provide Option act 425. Otherwise, the method proceeds to an inquiry sequence. In the inquiry sequence, if the game disabled inquiry 430 determines that games are disabled, then the method proceeds to a system use act 490. Otherwise, the method proceeds to a game required inquired 440, which, if met, proceeded to a play game and tally score act 470 prior to proceeding to the system use act 490. Next, the method proceeds to a turned on act 450. If the method approves of the game play (y) then the method proceeds to a begin game play act 480. Otherwise the method proceeds to the system use act 490. In the game play act 480 the method begins to play a game, and then to an aborted inquiry 482. If the game is aborted in the game aborted inquiry 482, then the method proceeds to the system use act 490. Otherwise, the method proceeds to the tally scores act 484 before proceeding to the system use act 490.

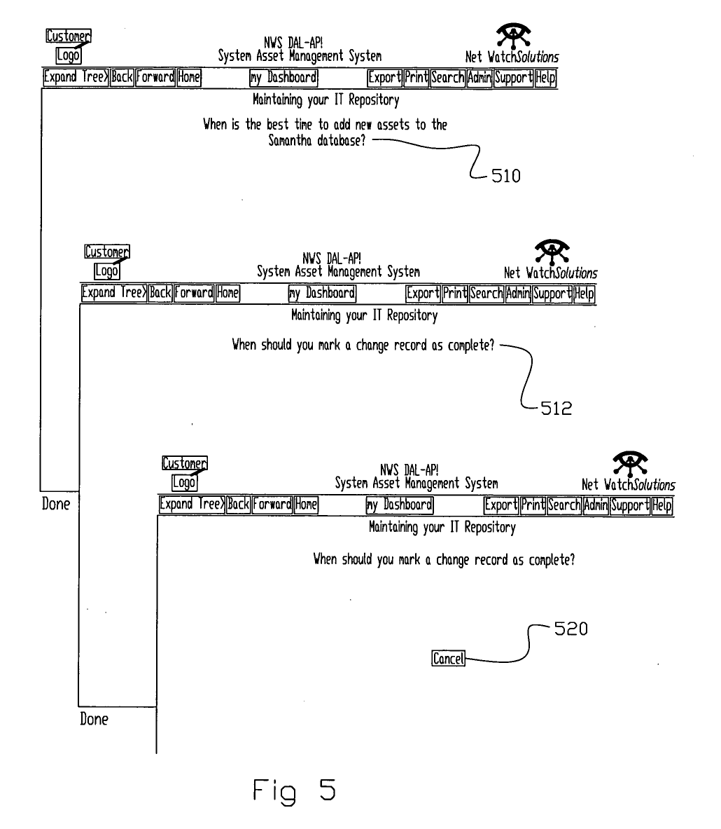

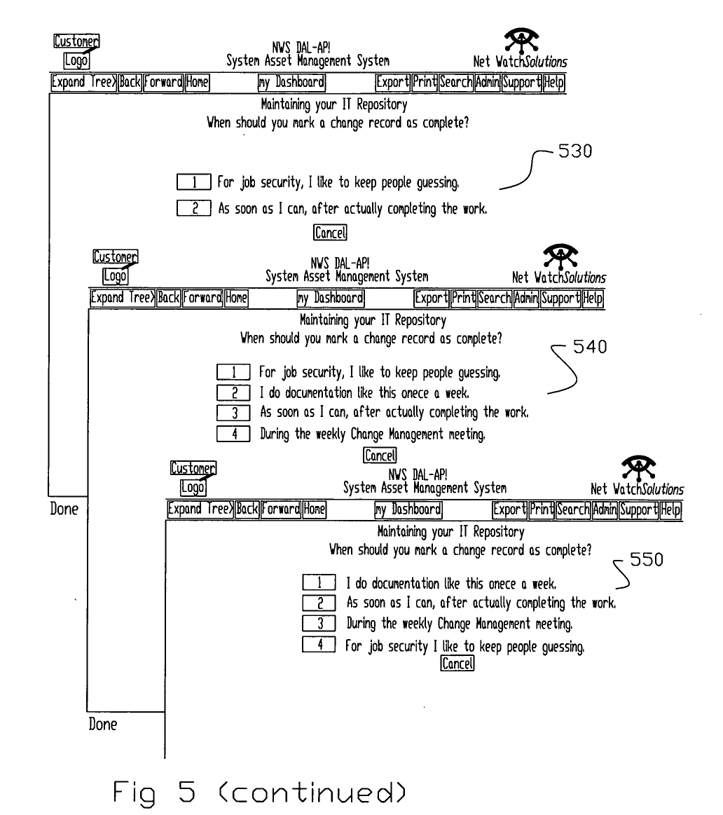

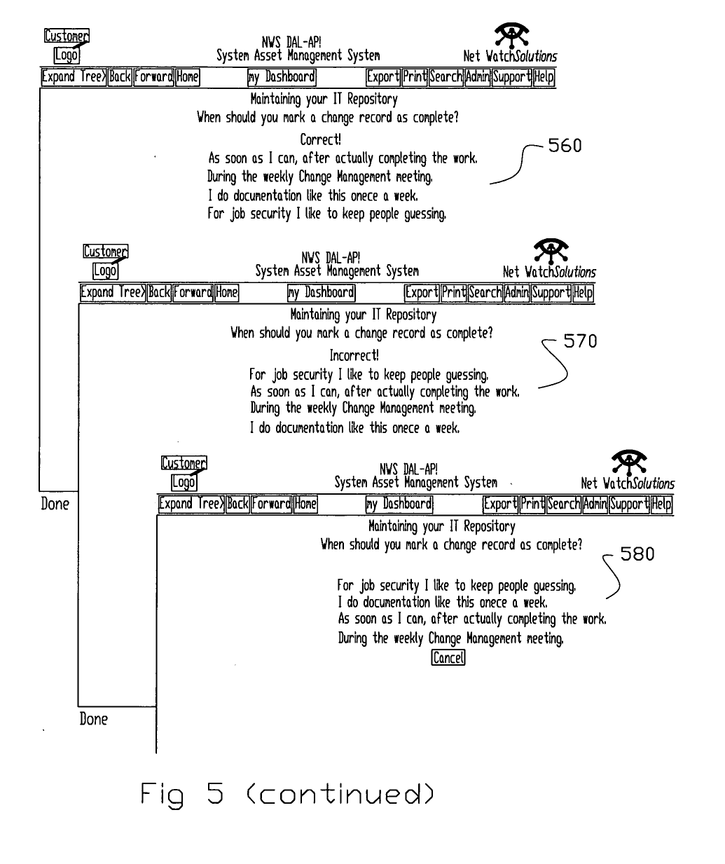

FIG. 5 illustrates a graphical user interface according to an embodiment of the invention. When game play begins, a trivia question is presented to the user 570. An element of chance is included, where upon subsequent system logons and game play, random questions may be presented 512. If game play is not required, an optional method to abort game play is provided 520.

After displaying the question, potential answers are displayed. For example, in one embodiment an first one potential answer is displayed, followed by a short delay, such as 1 second, then the second potential answer is displayed as illustrated 530, followed by a short delay, until all potential answers for the question are displayed at 540. An element of chance is included where potential answers are displayed in different order upon subsequent play of the same question as illustrated at 550.

The game provides an electronic method for a user to select the correct answer FIG. 560. A warning message, “Incorrect”, is displayed if the wrong answer is selected, and the correct answer is revealed 570. If no answer is selected within a short period of time, such as 3 seconds, the correct answer is revealed 580. Correct and wrong answers are saved to the NSM repository.

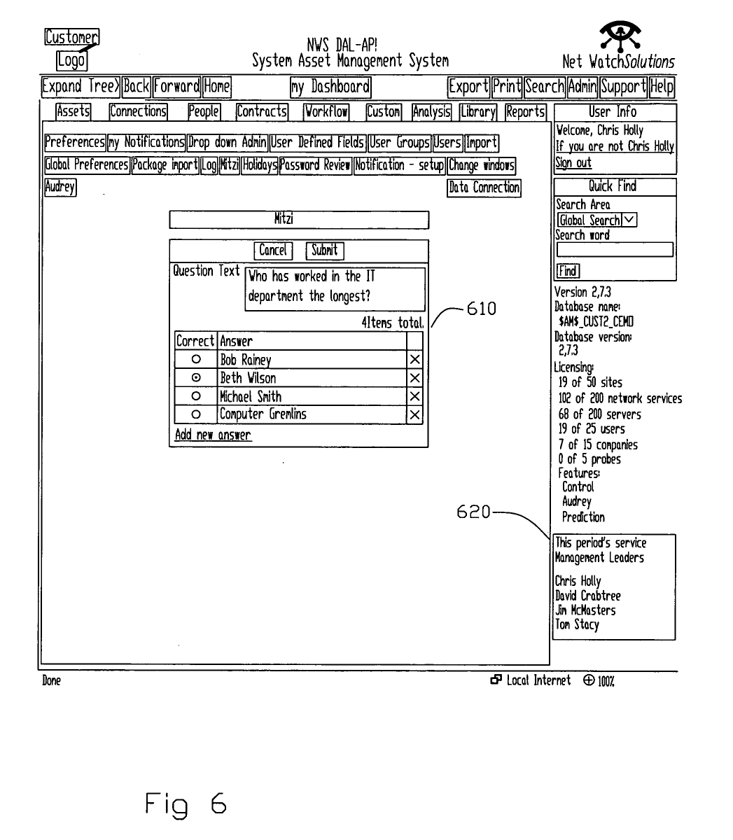

FIG. 6 illustrates a graphical user interface according to an embodiment of the invention, illustrating an example trivia question and showing score results. The Game Administrator 325 has the ability to use the Question & Answer Set-up 327 module to create trivia questions and answers, edit questions, add answers, edit answers, delete answers, and select the correct answer.

The choice of trivia questions helps ensure the game enhances the use of the NSM application. Trivia questions should include: 1) information about the data in the NSM repository, 2) information about the procedures of the IT department, and 3) questions about the people in the IT department.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application. Specifically, the invention may be altered, in ways readily apparent to those of ordinary skill in the art upon reading the present disclosure. It is therefore the intention that the appended claims and their equivalents be interpreted as broadly as possible in view of the prior art to include all such variations and modifications.

I claim:

1. A method of promoting use of and compliance with business software, comprising:
intercepting a standard use of a business software program;
adding software algorithms directing or allowing a user to play a game;
at the conclusion of the game, directing the user back to a standard use of the business software program.

2. The method of claim 1 wherein the business software is a network management solution.

3. The method of claim 1 wherein the game is added in a way to support a business mission without distracting from the business mission

4. The method of claim 1 wherein the game is a multiple-choice game comprising at least one question, and each question has a plurality of answer choices.

5. The method of claim 4 wherein the game includes an element of chance.

6. The method of claim 4 wherein the answer choices are based on answer parameters.

7. The method of claim 6 wherein answers selected by each user from answer choices are stored.

8. The method of claim 6 wherein the answer choices include a funny answer.

9. The method of claim 6 wherein the answer parameters include a passive network parameter, which does not require a user entry to maintain.

10. The method of claim 1 wherein the game has a component that is social to other people

11. The method of claim 10 wherein the social component displays the names of the game players with the highest scores to other people.

12. A method of promoting use and compliance with a network management solution, comprising:
logging into a network management solution;
defining a game for a plurality of users to play, the game related to the network management solution; and
managing the network management solution.

13. The method of claim 12 wherein the game supports a corporate mission without distracting from the corporate mission

14. The method of claim 12 wherein the game is a multiple-choice game comprising at least one question, and each question has a plurality of answer choices.

15. The method of claim 14 wherein the answer choices are based on network parameters.

16. A method of using gaming software that converts a general computing machine into a specific computing platform, the method comprising:
detecting a user login into a business software program;
directing a user to play a game;
at the conclusion of the game, directing the user to the business software program.

17. The method of claim 16 wherein the business software is a network management solution.

18. The method of claim 17 wherein the game is related to the network management solution.

19. The method of claim 16 wherein the game supports a corporate mission without distracting from the corporate mission

20. The method of claim 16 wherein the game is a multiple-choice game comprising at least one question, and each question has a plurality of answer choices.
